(19) United States
(12) Patent Application Publication
(10) Pub. No.: US 2015/0116064 A1
(43) Pub. Date: Apr. 30, 2015

(54) INDUCTOR HOUSING

(71) Applicant: Ford Global Technologies, LLC, Dearborn, MI (US)

(72) Inventors: Sudhir Kumar, Ann Arbor, MI (US); Behzad Vafakhah, Ann Arbor, MI (US); Shahram Zarei, Farmington Hills, MI (US); Tienli Wang, Troy, MI (US); Edward Chan-Jiun Jih, Troy, MI (US)

(73) Assignee: Ford Global Technologies, LLC, Dearborn, MI (US)

(21) Appl. No.: 14/064,448

(22) Filed: Oct. 28, 2013

(51) Int. Cl. H01F 27/22

(52) U.S. Cl. CPC H01F 27/22
USPC 336/61

(57) ABSTRACT

An example inductor housing includes, among other things, a base, a plurality of walls extending from the base to provide a cavity that receives an inductor, and a plurality of extensions of the base to communicate thermal energy from the base and the plurality of walls.

### BACKGROUND

This disclosure relates generally to an electric vehicle and, more particularly, to an inductor assembly used within a powertrain of an electric vehicle.

Generally, electric vehicles differ from conventional motor vehicles because electric vehicles are selectively driven using one or more battery-powered electric machines. Conventional motor vehicles, by contrast, rely exclusively on an internal combustion engine to drive the vehicle. Electric vehicles may use electric machines instead of, or in addition to, the internal combustion engine.

Example electric vehicles include hybrid electric vehicles (HEVs), plug-in hybrid electric vehicles (PHEVs), and battery electric vehicles (BEVs). Electric vehicles are typically equipped with a battery pack containing multiple battery cells that store electrical power for powering the electric machine. The battery cells may be charged prior to use, and recharged during a drive by a regeneration brake or engine.

Electric vehicles may include a voltage converter (DC-DC converter) connected between the battery and the electric machine. Electric vehicles that have AC electric machines also include an inverter connected between the DC-DC converter and the electric machine. A voltage converter increases (“boosts”) or decreases (“bucks”) the voltage potential to facilitate torque capability optimization. The DC-DC converter includes an inductor (or reactor) assembly, switches and diodes.

A typical inductor assembly includes a conductive coil that is wound around a magnetic core. The inductor assembly generates heat (thermal energy) as current flows through the coil. An existing method for cooling the DC-DC converter by circulating fluid through a conduit that is proximate to the inductor is disclosed in United States Published Application No. 2004/0045749 to Jaura et al. At high power loads, inductor temperatures can undesirably exceed constraint limits. To reduce thermal energy levels below the constraint limits, power is typically reduced. Reducing power is often undesirable.

### SUMMARY

An inductor housing according to an exemplary aspect of the present disclosure includes, among other things, a base, a plurality of walls extending from the base to provide a cavity that receives an inductor, and a plurality of extensions of the base to communicate thermal energy from the base and the plurality of walls.

In a further non-limiting embodiment of the foregoing inductor housing, the plurality of walls extend from a first side of the base in a first direction. The plurality of extensions extend from a second side of the base in a second direction that is different than the first direction.

In a further non-limiting embodiment of any of the foregoing inductor housings, the first direction is opposite the second direction.

In a further non-limiting embodiment of any of the foregoing inductor housings, the plurality of extensions comprises pins.

In a further non-limiting embodiment of any of the foregoing inductor housings, the pins have a generally circular cross-sectional profile.

In a further non-limiting embodiment of any of the foregoing inductor housings, the plurality of pins extend directly from the base.

In a further non-limiting embodiment of any of the foregoing inductor housings, the inductor housing includes a cold plate. The plurality of extensions extend from the base to an end portion that directly contacts the cold plate.

In a further non-limiting embodiment of any of the foregoing inductor housings, the base and the plurality of extensions are portions of a continuous, monolithic structure.

In a further non-limiting embodiment of any of the foregoing inductor housings, the plurality of extensions are arranged in an array of rows and columns, at least some of the columns are staggered relative to each other and relative to a direction of flow through the plurality of extensions to enhance turbulent flow.

An inductor assembly according to an exemplary aspect of the present disclosure includes, among other things, a magnetic core, a coil wound about the magnetic core, a base, a plurality of walls extending from the base to provide a cavity that receives the magnetic core and the coil, and a plurality of extensions of the base to communicate thermal energy from the base and the plurality of walls.

In a further non-limiting embodiment of the foregoing inductor assembly, the assembly includes an insulative material within the cavity. The potting compound separates the magnetic core and the coil from both the plurality of walls and the base.

In a further non-limiting embodiment of the foregoing inductor assembly, the insulative material comprises a potting compound.

In a further non-limiting embodiment of any of the foregoing inductor assemblies, the plurality of walls extend from a first side of the base in a first direction. The plurality of extensions extend from a second side of the base in a second direction that is different than the first direction.

In a further non-limiting embodiment of any of the foregoing inductor assemblies, the first direction is opposite the second direction.

In a further non-limiting embodiment of any of the foregoing inductor assemblies, the plurality of extensions comprise pins.

In a further non-limiting embodiment of any of the foregoing inductor assemblies, the base and the plurality of extensions are portions of a continuous, monolithic structure.

In a further non-limiting embodiment of any of the foregoing inductor assemblies, an electric vehicle powertrain includes the inductor assembly, and the inductor assembly is used in a voltage converter to boost or buck the battery pack voltage.

A method of cooling an inductor according to an exemplary aspect of the present disclosure includes, among other things, communicating thermal energy from an insulative material surrounding an inductor to a base of an inductor housing, and communicating thermal energy from the base directly to a plurality of extensions of the inductor housing.

In a further non-limiting embodiment of any of the foregoing methods, the base and the plurality of extensions are part of a continuous monolithic structure.

In a further non-limiting embodiment of any of the foregoing methods, the insulative material comprises a potting compound.

### DESCRIPTION OF THE FIGURES

The various features and advantages of the disclosed examples will become apparent to those skilled in the art from the detailed description. The figures that accompany the detailed description can be briefly described as follows:

FIG. 1 shows a schematic view of an example powertrain architecture for an electric vehicle.

FIG. 2 shows a highly schematic view of an inductor assembly used within the architecture of FIG. 1.

FIG. 3 shows a close-up, perspective view of an extension of the inductor assembly of FIG. 2.

FIG. 4 shows a perspective view of a housing of the FIG. 2 inductor assembly.

### DETAILED DESCRIPTION

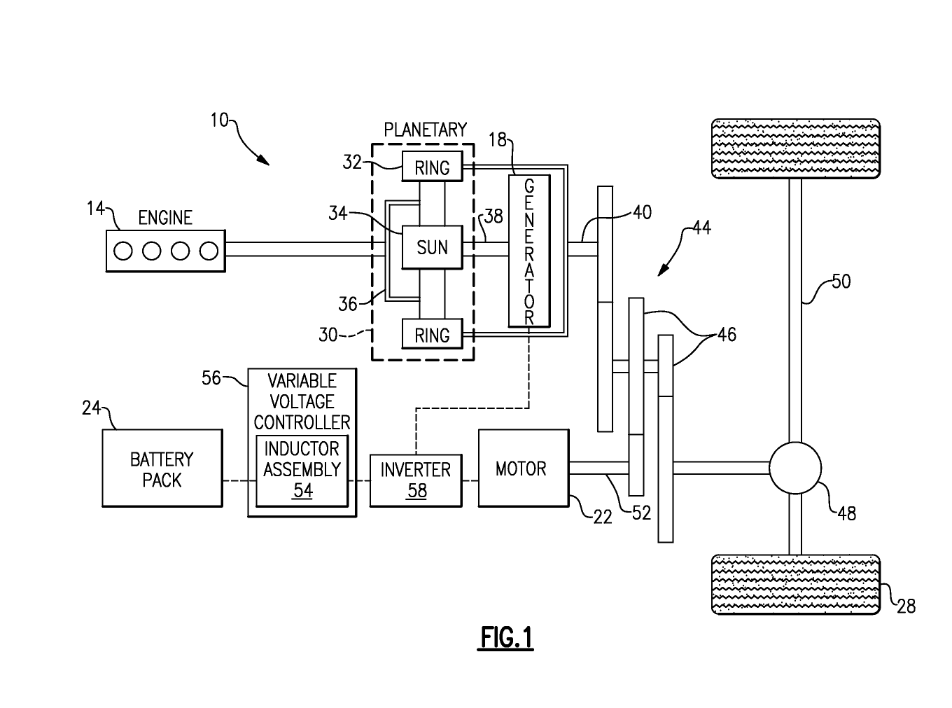

FIG. 1 schematically illustrates a powertrain architecture 10 for an electric vehicle. Although depicted as a hybrid electric vehicle (HEV), it should be understood that the concepts described herein are not limited to HEVs and could extend to other electrified vehicles, including, but not limited to, plug-in hybrid electric vehicles (PHEVs) and battery electric vehicles (BEVs).

In one embodiment, the powertrain 10 is a powersplit powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electric vehicle.

The engine 14, which is an internal combustion engine in this example, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 may be driven by engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 (i.e., the second electric machine) can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an example type of electric vehicle battery assembly. The battery pack 24 may be a high voltage battery that is capable of outputting electrical power to operate the motor 22 and the generator 18. Other types of energy storage devices and/or output devices can also be used with the electric vehicle.

The example powertrain 10 includes an inductor assembly 54 that is used in a DC to DC converter to step up or step down the battery pack 24 voltage. The inductor assembly 54 is part of a variable voltage controller 56.

The example powertrain 10 may further include an inverter 58 to convert current moving to and from the battery pack 24.

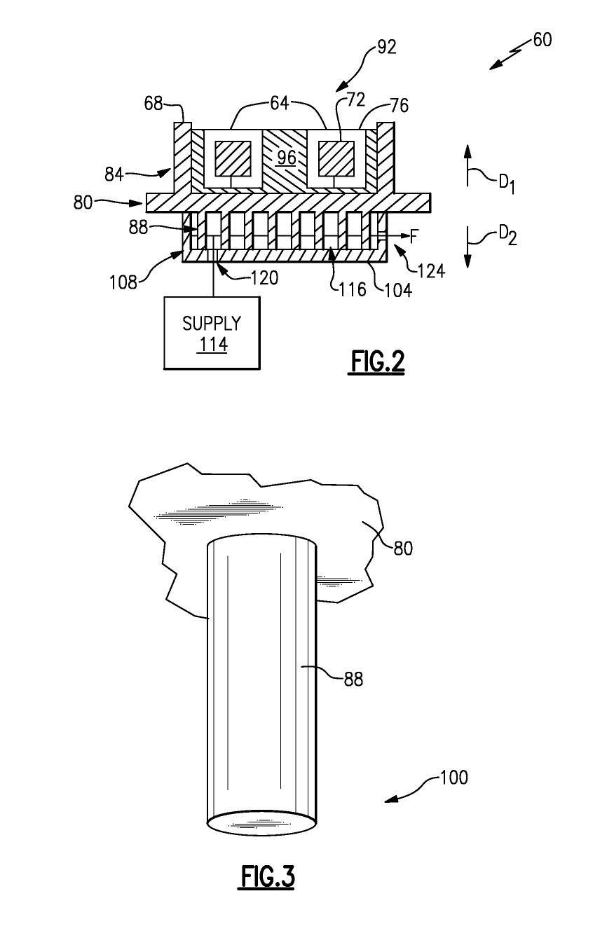

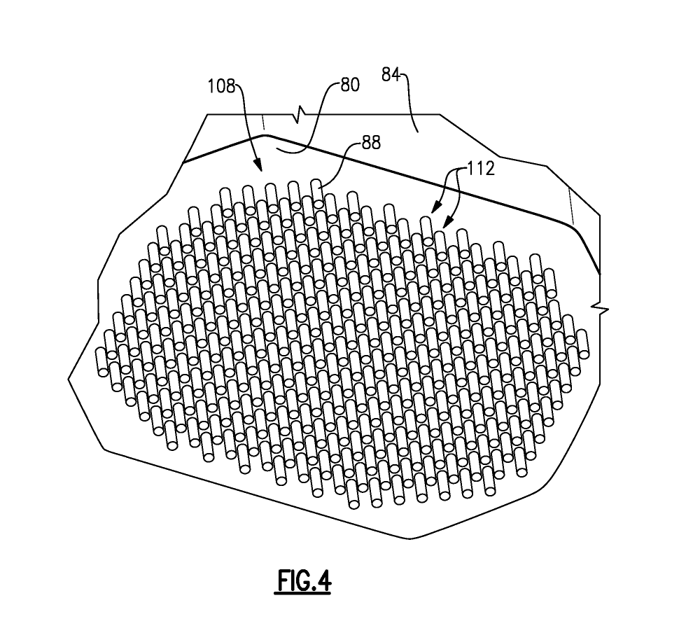

Referring now to FIGS. 2 to 4, the example inductor assembly 54 includes an inductor 64 held within a housing 68. The inductor 64 includes a magnetic core 72 and a coil 76 wrapped around at least a portion of the magnetic core 72.

The housing 68 includes a base 80. A plurality of walls 84 extend from the base in a first direction D₁. A plurality of extensions 88 extend from the base 80 in a second direction D₂. The second direction D₂ is opposite the first direction D₁.

The walls 84 provide a cavity 92 that receives the inductor 64. In this example, the inductor 64 is disposed in an insulative material, such as a potting compound 96, that separates the inductor 64 from the walls 84 in the base 80. In such an example, the inductor 64 does not directly contact the walls 84 or the base 80.

The extensions 88 extend from the base 80 to an end portion 100 that directly contacts a cold-plate 104. In another example, the extensions 88 do not directly contact the cold-plate 104. The extensions 88 are arranged in an array 108 having rows and columns 112. In still other examples, no extensions are used, and the base 80 directly contacts the cold-plate 104.

In this example, the cold-plate 104 is a container that is bolted to a bottom surface of the housing 68. A lid (not shown) can be secured to the housing 68 to enclose the cavity 92. Seals, such as O-ring seals or a silicone-based sealant, can be used to make the interfaces essentially leak-proof. The cold-plate 104 can be aluminum or copper, for example.

During operation of the inductor assembly 54, the inductor 64 generates thermal energy. Thermal energy communicates from the inductor 64 through the potting compound 96 to the base 80 of the housing 68. The thermal energy communicates directly from the base 80 to the extensions 88. Some thermal energy from the extensions 88 may move into the cold-plate 104. Other thermal energy is carried away form the extensions 88 by a flow F, such as a flow of water or air.

The flow F moves from a supply 114 through the array 108. The flow F moves through gaps and spaces 116 in the array 108. The columns 112 are staggered relative to a direction D of flow through the array 108. Staggering the columns 112 enhances turbulent flow through the array 108, which can enhance thermal energy transfer from the extensions 88 to the flow F.

The flow F enters an area between the cold-plate 104 and the base 80 through an inlet 120. The flow F exits the area between the cold-plate 104 and the base 80 though an outlet 124. The cold-plate 104 defines both the inlet 120 and the outlet 124 in this example.

The example extensions 88 have a generally circular cross-sectional profile. In other examples, the extensions 88 have other cross-sectional profiles, such as diamond, rectangular, or square-shaped cross-sectional profiles. The extensions 88 can be plate fins or pin fins.

A length L of the example extensions 88 is from 8 to 10 millimeters. That is, the example extensions 88 extend from 8 to 10 millimeters away from the base 80. A diameter D of the extensions 88 is approximately 2.5 millimeters. Thus, the diameter D of the example extensions 88 is from 25 to 32 percent of the length L of the extensions.

The array 108 of the extensions 88 can be optimized for maximum thermal performance, reduced resistance to the flow, reduced pressure drop, as well as manufacturing ease.

Other parameters of the extensions 88 that can be optimized include the overall shape of the extensions 88, the dimensions, of the extensions 88, the pitch, and the tapering angle from the portion of the extensions 88 attached directly to the base 80 to the end portions 100.

The housing 68 is a monolithic structure. That is, the walls 84, the base 80, and the extensions 88 are all formed of the same continuous piece of material.

The example housing 68 may be machined from a single block of material. In another example, the housing 68 is cast from a powdered aluminum or copper material. Whether machined or die cast from powder metal, the housing 68 is continuous piece of material.

Machining can be particularly appropriate when manufacturing small number of units. Die casting can be particularly appropriate for high volume manufacturing. The die casting process starts from pulverized metal, melting and injecting in preforms, and finally ends with sintering and stamping the finished units.

Features of at least some of the disclosed examples include providing an inductor housing that is effectively cooled without utilizing a layer of thermal grease and other layers to enhance thermal energy removal. In some examples, thermal resistance within the inventive assemblies is reduced by about 20 percent from prior art designs. The assembly process is also simplified due, in part, to less parts. The assembly process is also simplified by eliminating the thermal grease. The continuous material medium between the extensions and base removes contact thermal resistance associated with base-plates of conventional designs.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

1. An inductor housing, comprising:
a base;
a plurality of walls extending from the base to provide a cavity that receives an inductor; and
a plurality of extensions of the base to communicate thermal energy from the base and the plurality of walls.

2. The inductor housing of claim 1, wherein the plurality of walls extend from a first side of the base in a first direction, and the plurality of extensions extend from a second side of the base in a second direction that is different than the first direction.

3. The inductor housing of claim 2, wherein the first direction is opposite the second direction.

4. The inductor housing of claim 1, wherein the plurality of extensions comprises pins.

5. The inductor housing of claim 4, wherein the pins have a generally circular cross-sectional profile.

6. The inductor housing of claim 4, wherein the pins extend directly from the base.

7. The inductor housing of claim 1, including a cold plate, the plurality of extensions extending from the base to an end portion that directly contacts the cold plate.

8. The inductor housing of claim 1, wherein the base, the walls, and the plurality of extensions are portions of a continuous, monolithic structure.

9. The inductor housing of claim 1, wherein the plurality of extensions are arranged in an array of rows and columns, at least some of the columns being staggered relative to each other and relative to a direction of flow through the plurality of extensions to enhance turbulent flow.

10. (canceled)

11. The inductor housing of claim 1, including an insulative material within the cavity, the insulative material separating the magnetic core and a coil from both the plurality of walls and the base.

12. The inductor housing of claim 11, wherein the insulative material comprises a potting compound.

13.-17. (canceled)

18. A method of cooling an inductor, comprising:
communicating thermal energy from an insulative material surrounding an inductor to a base of an inductor housing;
communicating thermal energy from the base directly to a plurality of extensions of the base; and
communicating thermal energy from the plurality of extensions using a liquid held within a container.

19. The method of claim 18, wherein the base, the walls, and the plurality of extensions are part of a continuous monolithic structure.

20. The method of claim 18, wherein the insulative material comprises a potting compound.

21. An inductor assembly comprising the inductor housing of claim 1, and further comprising a container providing an open area to receive the plurality of extensions.

22. The inductor assembly of claim 21, wherein the container directly contacts the base.

23. The inductor assembly of claim 21, wherein the container holds a liquid within the open area.

24. The inductor assembly of claim 23, further comprising an inlet to receive the liquid and an outlet to communicate the liquid from the container, the plurality of extensions arranged in an array of rows and columns, at least some of the columns being staggered relative to each other and relative to a direction of flow of the liquid from the inlet to the outlet.

25. An electric vehicle powertrain, comprising:
a voltage converter;
a battery pack of an electric vehicle; and
an inductor assembly of the voltage converter that selectively boosts or bucks a voltage from the battery pack, the inductor assembly including a base, a plurality of walls extending from the base to provide a cavity that receives an inductor, and a plurality of extensions of the base, wherein the plurality of extensions are held within an open area of a container and the plurality of extensions communicate thermal energy from the base to the container.

26. The electric vehicle powertrain of claim 25, further comprising a fluid communicating through the open area of the container.
